(19) United States
(12) Patent Application Publication
(10) Pub. No.: US 2025/0091854 A1
(43) Pub. Date: Mar. 20, 2025

(54) BEVERAGE DISPENSING SYSTEM

(71) Applicant: Derrick Dupuy, Slidell, LA (US)

(72) Inventor: Derrick Dupuy, Slidell, LA (US)

(21) Appl. No.: 18/370,080

(22) Filed: Sep. 19, 2023

(51) Int. Cl. B67D 3/04; B67D 3/00

(52) U.S. Cl. CPC B67D 3/047; B67D 3/0032; B67D 3/0083

(57) ABSTRACT

A beverage dispensing system for dispensing a fluid from a bottle includes a housing having a perimeter wall that is attached to and extends downwardly from a top wall to bound an interior space. A tubing is positioned within the interior space, forming a conduit between the top wall and the perimeter wall. The top wall has an opening that is configured to receive the bottle. The conduit is fluidly coupled to the opening. The fluid can travel into the tubing and through the conduit when the opening has received the bottle. A spout having an inlet portion and an outlet portion is coupled to the perimeter wall. The spout permits the fluid to flow from the conduit into the inlet portion and outwardly through the outlet portion. A valve coupled to the spout controls the flow through the outlet portion. A decorative indicium may be positioned on the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to beverage dispensers and more particularly pertains to a new beverage dispenser for receiving a neck of a of an inverted bottle and dispensing fluid therefrom.

### (2) Description of Related Art Including Information Disclosed Under 37 CFR 1.97 and 1.98

The prior art relates to beverage dispensers. The prior art discloses devices that can support inverted beverage containers, allowing the beverage within the containers to be dispensed through tap members or valves using gravity. However, these devices are typically sold with prefabricated designs, limiting their use. There is a need in the art for a custom beverage dispenser that can be tailored to any theme, including a social event, function, company, or group. Such a dispenser would be highly useful for advertising and raising awareness about the theme of the dispenser.

### BRIEF SUMMARY OF THE INVENTION

An embodiment of the disclosure meets the needs presented above by generally comprising a beverage dispenser system comprising a bottle containing a fluid and a housing. The housing has a top wall and a perimeter wall that is attached to and extends downwardly from the top wall. The top wall and perimeter wall bound an interior space. A tubing is positioned within the interior space, forming a conduit through the interior space between the top wall and the perimeter wall. The top wall has an opening therein. The opening is configured to receive at least a portion of the bottle. The conduit is fluidly coupled to the opening, wherein the fluid can travel into the tubing and through the conduit when the opening has received the bottle. A spout is coupled to the perimeter wall. The spout has an inlet portion and an outlet portion. The inlet portion is in fluid communication with the conduit, wherein the spout is configured to permit the fluid to flow from the conduit into the inlet portion and outwardly through the outlet portion. A valve is coupled to the spout. The valve is movable between an open position and a closed position, wherein the fluid flows outwardly through the outlet portion when the valve is in the open position, and wherein the fluid is inhibited from flowing outwardly through the outlet portion when the valve is in the closed position. A decorative indicium may be positioned on the housing, for example displaying a logo, a solid color, a pattern, or an image that is associated with a user.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a beverage dispensing system according to an embodiment of the disclosure.

FIG. 2 is a front view of an embodiment of the disclosure.

FIG. 3 is a cross-sectional view of an embodiment of the disclosure.

FIG. 4 is a front view of an embodiment of the disclosure.

FIG. 5 is a cross-sectional view of an embodiment of the disclosure.

FIG. 6 is a detailed view of an embodiment of the disclosure.

FIG. 7 is a perspective view of an embodiment of the disclosure.

FIG. 8 is a perspective view of an embodiment of the disclosure.

FIG. 9 is an in-use view of an embodiment of the disclosure.

FIG. 10 is an isometric view of an embodiment of the disclosure.

FIG. 11 is an isometric embodiment view of the disclosure.

### DETAILED DESCRIPTION OF THE INVENTION

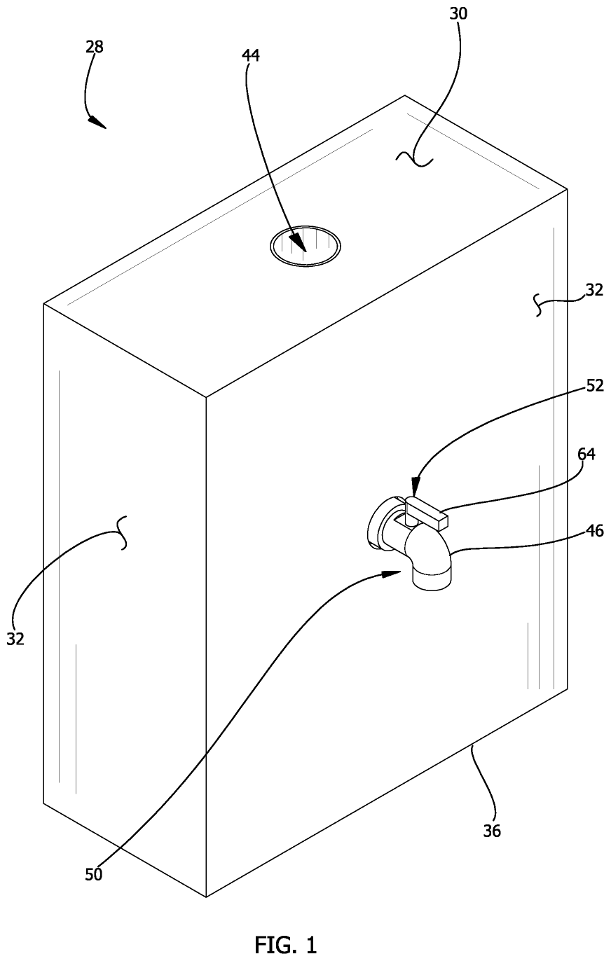

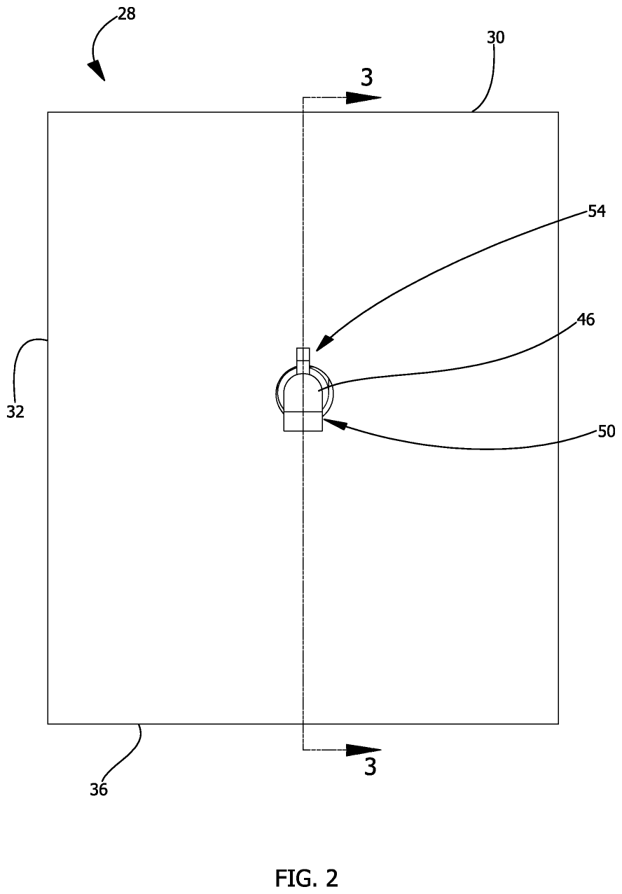

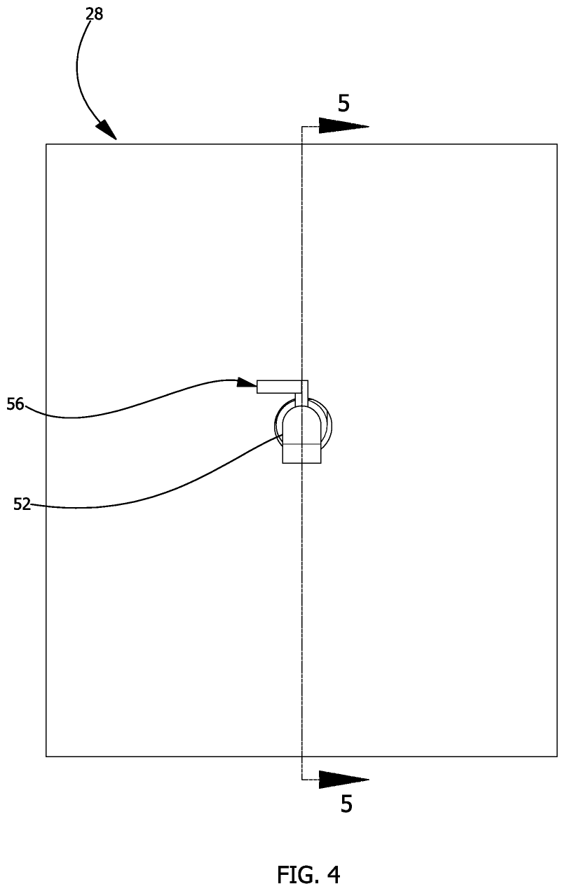

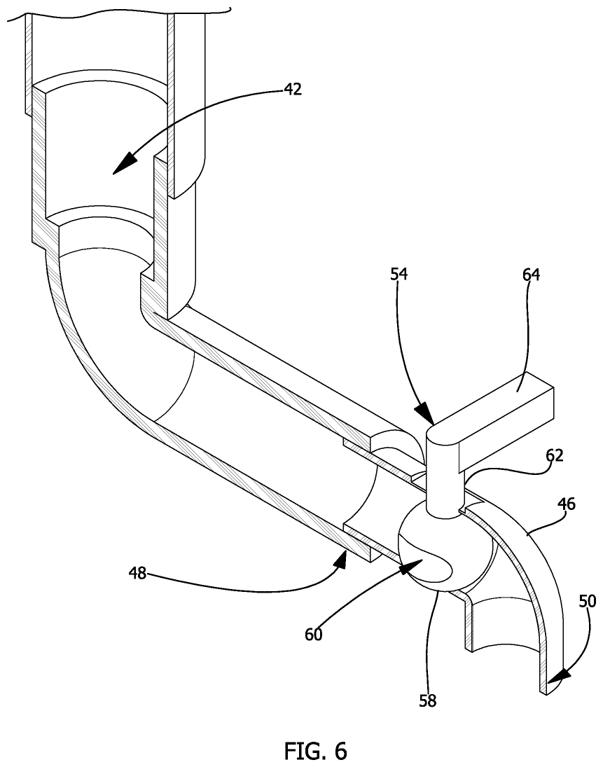

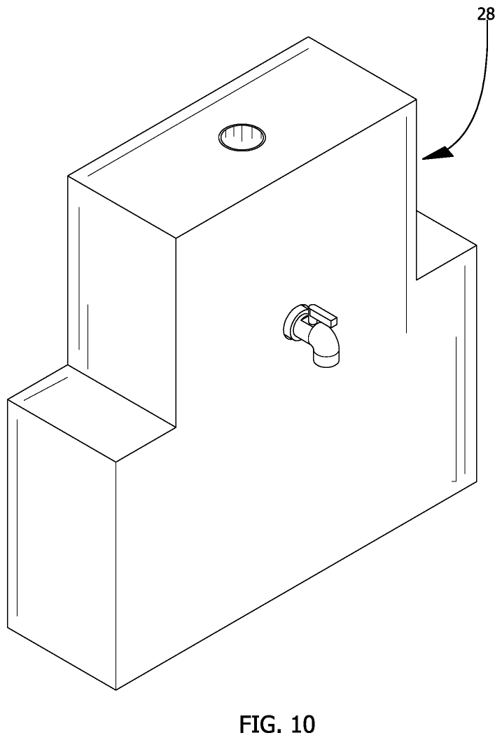

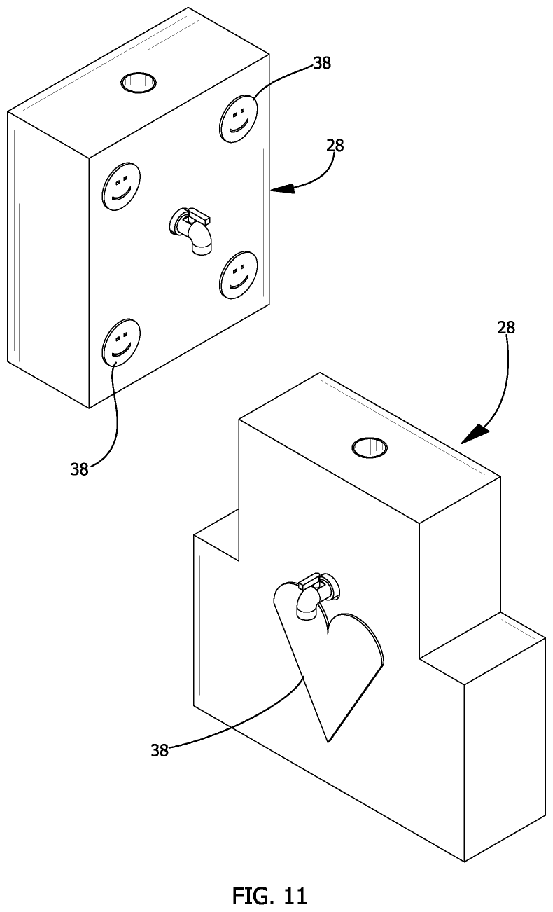

With reference now to the drawings, and in particular to FIGS. 1 through 11 thereof, a new beverage dispenser embodying the principles and concepts of an embodiment of the disclosure and generally designated by the reference numeral 10 will be described.

As best illustrated in FIGS. 1 through 11, the beverage dispensing system 10 generally comprises a bottle 20 containing a fluid 26 and a housing 28 through which the fluid 26 is dispensed. The bottle 20 may have a neck 22 and a body 24, the body 24 extending downwardly from the neck 22. For example, the bottle 20 may be a wine bottle, a liquor bottle, a water bottle, or any other bottle.

The housing 28 has a top wall 30 and a perimeter wall 32 that is attached to and extends downwardly from the top wall 30. The top wall 30 and the perimeter wall 32 bound an interior space 34. In embodiments, a bottom wall 36 may be attached to the perimeter wall 32 opposite the top wall 30. For example, the bottom wall 36 may be flat and configured to facilitate stable placement of the housing 28 on a surface. In other embodiments, the bottom wall 36 may define a gap opening into the interior space 34, for example to reduce the weight of the housing 28.

A decorative indicium 38 may be positioned the housing 28. For example, the decorative indicium 38 may be positioned on the top wall 30 or the perimeter wall 32. Embodiments of the decorative indicium 38 comprise at least one of a logo, a solid color, a pattern, or an image. The decorative indicium 38 may be associated with a user, such as a company logo, a team mascot, or a particular color palette. The decorative indicium 38 may also be associated with a particular theme, social cause, or event, such as an image or pattern associated with a particular holiday or occasion. The decorative indicium 38 can draw attention to the user, theme, event, or cause when viewed by the public.

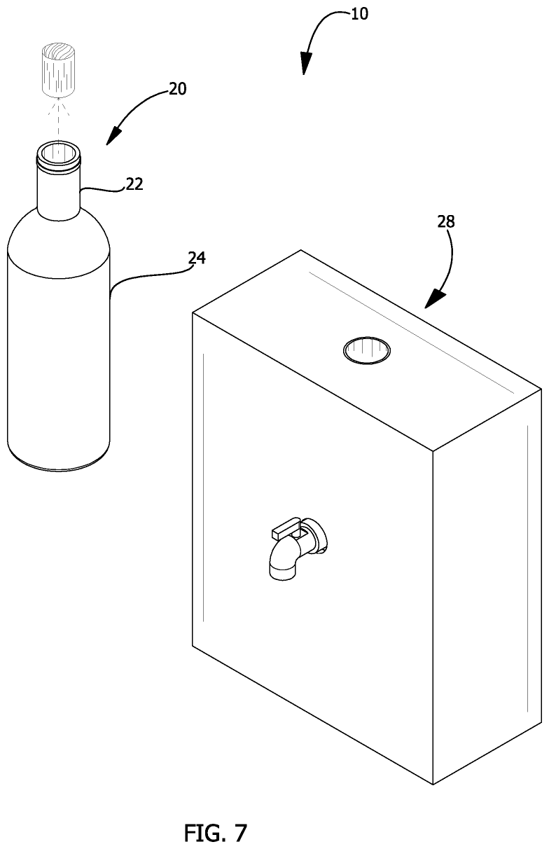

A tubing 40 is positioned within the interior space 34. The tubing 40 forms a conduit 42 through the interior space 34 between the top wall 30 and the perimeter wall 32. The top wall 30 has an opening 44 therein. The opening 44 is configured to receive at least a portion of the bottle 20, such as the neck 22 of the bottle 20. The conduit 42 is fluidly coupled to the opening 44. The fluid 26 can therefore travel into the tubing 40 and through the conduit 42 when the opening 44 has received the bottle 20. In some embodiments, the neck 22 may have a size that is complementary to the opening 44 such that the bottle 20 is supported in an inverted position when the neck 22 is within the opening 44. In others, the opening 44 may have a size that is complementary to the neck 22, or other portion of the bottle 20 that is received by the opening 44, such that the bottle 20 is supported in the inverted position when the bottle 20 is within the opening 44. FIGS. 7-9 provide exemplary depictions of the bottle 20 being received by the opening 44 and being supported in the inverted position.

A spout 46 is coupled to the housing 28, for example being positioned on the perimeter wall 32. The spout 46 may extend outwardly from the perimeter wall 32. The spout 46 generally has an inlet portion 48 and an outlet portion 50. The inlet portion 48 is in fluid communication with the conduit 42. The spout 46 is configured to permit the fluid 26 to flow from the conduit 42 into the inlet portion 48 and outwardly through the outlet portion 50. In some embodiments, the spout 46 is positioned on the perimeter wall 32 at a height above the bottom wall 36 to accommodate a glass being placed beneath the outlet portion 50 to receive the fluid 26. For example, the outlet portion 50 may be positioned on the perimeter wall 32 at least 6.0 inches above the bottom wall 36 to accommodate a wine glass.

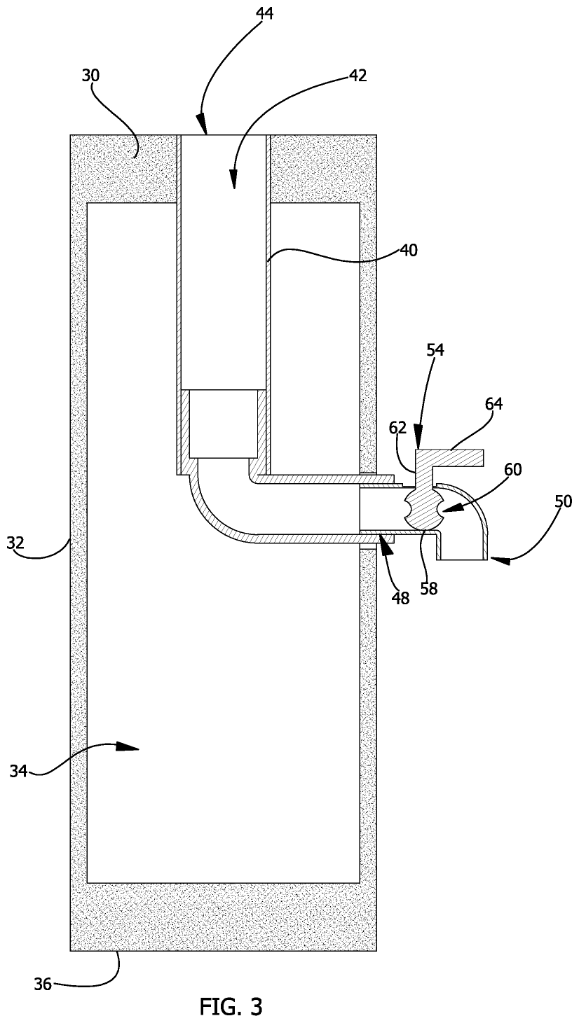

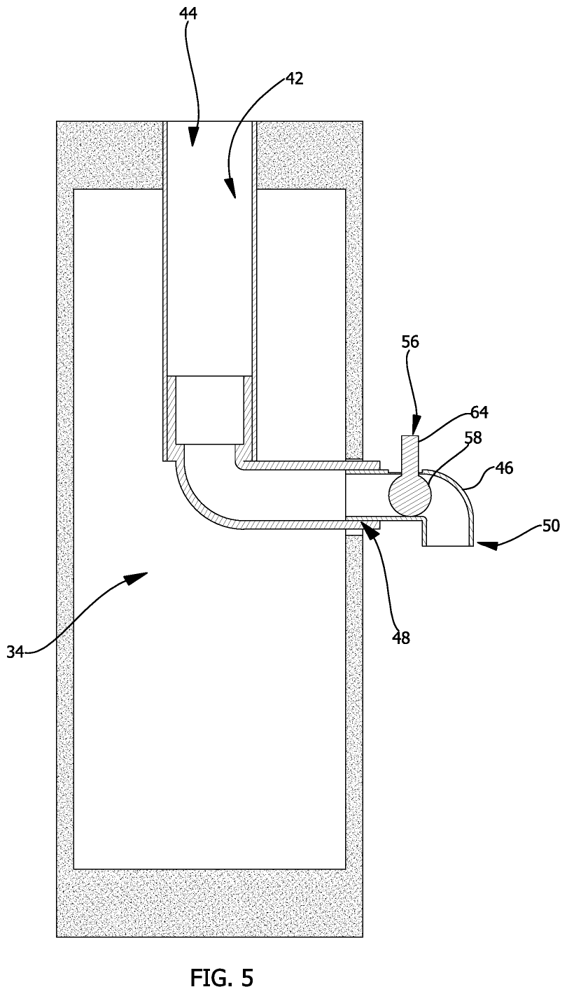

A valve 52 is coupled to the spout 46. The valve 52 is movable between an open position 54, for example as shown in FIG. 3, and a closed position 56, for example as shown in FIG. 5. The fluid 26 flows outwardly through the outlet portion 50 when the valve 52 is in the open position 54. The fluid 26 is inhibited from flowing outwardly through the outlet portion 50 when the valve 52 is in the closed position 56. Any valve 52 may be used to selectively control the flow of the fluid 26 through the outlet portion 50. For example, the valve 52 may comprise a turn-ball valve.

In other embodiments, the valve 52 may generally include a ball 58 that is positioned within the spout 46. The ball 58 creates a barrier between the inlet portion 48 and the outlet portion 50 when the valve 52 is in the closed position 56. The ball 58 may have a channel 60 extending therethrough, wherein the fluid can flow through the channel 60 when the valve 52 is in the open position 54. A ball valve stem 62 may extend upwardly from the ball 58 through the valve 52. A handle 64 may be coupled to the ball valve stem 62, wherein rotation of the handle 64 rotates the ball valve stem 62, which rotates the ball 58 thereby moving the position of the channel 60 relative to the spout 46 to alternate the valve 52 between the closed position 56 and the open position 54.

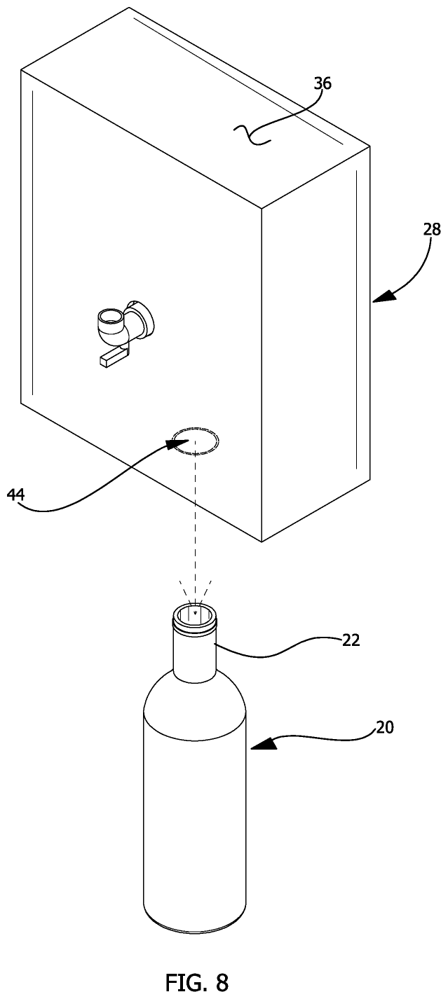

The housing 28 may be formed of any suitable material. In example embodiments, the housing 28 is formed of a mixture comprising cement and sand. In other embodiments, alternative materials are used, such as wood, plastic, glass, and other natural or synthetic materials. The housing 28 may be tipped upside down to position the bottle 20 within the opening 44, as shown in FIG. 8. The housing 28 may therefore be relatively lightweight, for example weighing no more than 15.0 pounds. In embodiments, the housing 28 may have any shape. Some of the figures depict the housing 28 having a rectangular shape, while other figures depict the housing 28 having an upside-down T shape. Other shapes may also be used, for example based on the preferences of the user or to correlate with the theme of the decorative indicium 38. The figures are meant as illustrative examples only and should not be construed to limit the shape of the housing 28 to any particular embodiment.

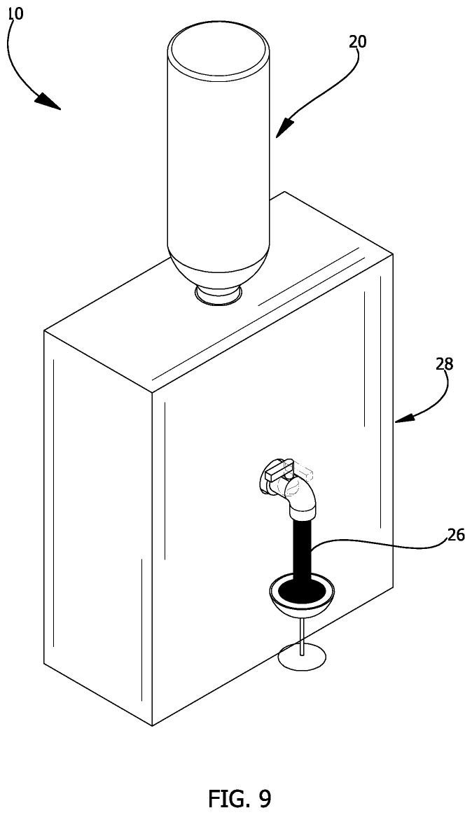

In use, the user can open the bottle 20, as shown in FIG. 7. The user can then invert the housing 28, as shown in FIG. 8. The user can turn the housing 28 upside down and place the neck 22, or other portion of the bottle 20, into the opening 44. As shown in FIG. 9, the user can then turn the housing right-side-up, so that the bottle 20 is in the inverted position over the housing 28. The user can then turn the valve 52 to the open position 54 so that the fluid 26 can flow out of the bottle 20, through the conduit 42 formed by the tubing 40, through the spout 46, and out of the outlet portion 50. The user may position a glass under the spout 46 to receive the fluid. Because the bottle 20 is inverted over the housing 28, gravity can facilitate the flow of the fluid 26 through the housing 28. With the decorative indicium 38, the user can advertise a person, company, theme, or cause using the beverage dispensing system 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A beverage dispenser system comprising:
a bottle containing a fluid;
a housing having a top wall and a perimeter wall being attached to and extending downwardly from the top wall, the top wall and perimeter wall bounding an interior space;
a tubing being positioned within the interior space, the tubing forming a conduit through the interior space between the top wall and the perimeter wall;
the top wall having an opening therein, the opening being configured to receive at least a portion of the bottle, the conduit being fluidly coupled to the opening, wherein the fluid can travel into the tubing and through the conduit when the opening has received the bottle;
a spout being coupled to the perimeter wall, the spout having an inlet portion and an outlet portion, the inlet portion being in fluid communication with the conduit, wherein the spout is configured to permit the fluid to flow from the conduit into the inlet portion and outwardly through the outlet portion; and
a valve being coupled to the spout, the valve being movable between an open position and a closed position, wherein the fluid flows outwardly through the outlet portion when the valve is in the open position, wherein the fluid is inhibited from flowing outwardly through the outlet portion when the valve is in the closed position.

2. The beverage dispenser system of claim 1, further comprising a decorative indicium being positioned the housing.

3. The beverage dispenser system of claim 2, the decorative indicium further comprising at least one of a logo, a solid color, a pattern, or an image.

4. The beverage dispenser system of claim 1, the bottle further comprising a neck and a body, the body extending downwardly from the neck.

5. The beverage dispenser system of claim 4, wherein the opening has a size complementary to the neck such that the bottle is supported in an inverted position when the neck is within the opening.

6. The beverage dispenser system of claim 1, wherein the spout extends outwardly from the perimeter wall.

7. The beverage dispenser system of claim 1, the housing further comprising a bottom wall being attached to the perimeter wall opposite the top wall.

8. The beverage dispenser system of claim 7, wherein the outlet portion is positioned on the perimeter wall at least 6.0 inches above the bottom wall.

9. The beverage dispenser system of claim 1, wherein the valve comprises a turn-ball valve.

10. The beverage dispenser system of claim 1, the valve further comprising:
a ball being positioned within the spout, the ball creating a barrier between the inlet portion and the outlet portion when the valve is in the closed position;
the ball having a channel extending therethrough, wherein the fluid can flow through the channel when the valve is in the open position;
a ball valve stem extending upwardly from the ball through the valve; and
a handle being coupled to the ball valve stem, wherein rotation of the handle rotates the ball valve stem, which rotates the ball, thereby moving the position of the channel relative to the spout to alternate the valve between the closed position and the open position.

11. The beverage dispenser system of claim 1, wherein the housing is formed of a mixture comprising cement and sand.

12. The beverage dispenser system of claim 1, wherein the housing weighs no more than 15.0 pounds.

13. The beverage dispenser system of claim 1, wherein the housing has a rectangular shape.

14. A wine dispenser system comprising:
a wine bottle having a neck and a body, the body extending downwardly from the neck, the wine bottle containing a fluid;
a housing having a top wall and a perimeter wall being attached to and extending downwardly from the top wall, the top wall and perimeter wall bounding an interior space, a bottom wall being attached to the perimeter wall opposite the top wall, the bottom wall being flat;
a decorative indicium being positioned the housing, the decorative indicium comprising at least one of a logo, a solid color, a pattern, or an image;
a tubing being positioned within the interior space, the tubing forming a conduit through the interior space between the top wall and the perimeter wall;
the top wall having an opening therein, the opening being configured to receive the neck of the wine bottle, the conduit being fluidly coupled to the opening, wherein the fluid can travel into the tubing and through the conduit when the opening has received the wine bottle, the neck having a size complementary to the opening such that the wine bottle is supported in an inverted position when the neck is within the opening;
a spout being coupled to the perimeter wall, the spout extending outwardly from the perimeter wall, the spout having an inlet portion and an outlet portion, the inlet portion being in fluid communication with the conduit, wherein the spout is configured to permit the fluid to flow from the conduit into the inlet portion and outwardly through the outlet portion, the outlet portion being positioned on the perimeter wall at least 6.0 inches above the bottom wall;
a valve being coupled to the spout, the valve being movable between an open position and a closed position, wherein the fluid flows outwardly through the outlet portion when the valve is in the open position, wherein the fluid is inhibited from flowing outwardly through the outlet portion when the valve is in the closed position, the valve comprising a turn-ball valve, the turn-ball valve including:
a ball being positioned within the spout, the ball creating a barrier between the inlet portion and the outlet portion when the valve is in the closed position;
the ball having a channel extending therethrough, wherein the fluid is able to flow through the channel when the valve is in the open position;
a ball valve stem extending upwardly from the ball through the valve; and
a handle being coupled to the ball valve stem, wherein rotation of the handle rotates the ball valve stem, which rotates the ball thereby moving the position of the channel relative to the spout to alternate the valve between the closed position and the open position.

15. The beverage dispenser system of claim 14, wherein the housing is formed of a mixture comprising cement and sand.

16. The beverage dispenser system of claim 14, wherein the housing weighs no more than 15.0 pounds.

17. The beverage dispenser system of claim 14, wherein the housing has a rectangular shape.
